(19) United States
(12) Patent Application Publication
(10) Pub. No.: US 2025/0039985 A1
(43) Pub. Date: Jan. 30, 2025

(54) ELECTRONIC APPARATUS, USER TERMINAL, AND CONTROL METHOD THEREOF

(71) Applicant: SAMSUNG ELECTRONICS CO., LTD., Suwon-si (KR)

(72) Inventors: Hai DUONG VAN, Honoi (VN); Minh Hieu Nguyen, Hanoi (VN); Dien Dang Thi, Hanoi (VN); Anh Dung Phan, Hanoi (VN); Ngoc Son Vo, Hanoi (VN)

(73) Assignee: SAMSUNG ELECTRONICS CO., LTD., Suwon-si (KR)

(21) Appl. No.: 18/811,299

(22) Filed: Aug. 21, 2024

Related U.S. Application Data
(63) Continuation of application No. PCT/KR2024/010212, filed on Jul. 16, 2024.

(30) Foreign Application Priority Data
Jul. 25, 2023 (KR) 10-2023-0096988

(51) Int. Cl. H04W 76/50; H04W 76/10

(52) U.S. Cl. CPC H04W 76/50; H04W 76/10

(57) ABSTRACT

An electronic apparatus includes: a memory for storing an instruction; and a processor operatively connected to the communication interface and the memory, and configured to execute the instruction to: identify a wireless connection state of a user terminal based on information on the wireless connection state of the user terminal in a case that an urgent call event to the user terminal occurs, transmit a wireless connection enable request to a server by using a predetermined existing connection, based on identifying that the wireless connection state of the user terminal is a disable state, and transmit an urgent call to the user terminal in a case that: the processor receives a response signal from the user terminal enabling its wireless connection after receiving the wireless connection enable request from the server, or a predetermined time elapses.

### CROSS-REFERENCE TO RELATED APPLICATIONS

This application is a bypass continuation of International Application No. PCT/KR2024/010212, filed on Jul. 16, 2024, which is based on and claims priority to Korean Patent Application No. 10-2023-0096988, filed on Jul. 25, 2023, in the Korean Intellectual Property Office, the disclosures of which are incorporated by reference herein in their entireties.

### BACKGROUND

### 1. Field

The disclosure relates to an electronic apparatus, a user terminal, and a control method thereof, and more particularly, to an electronic apparatus, a user terminal, and a control method thereof for transmitting an urgent call when wireless communication of the user terminal is turned off.

### 2. Description of the Related Art

In a real situation, a user may turn off wireless communication of a user terminal for various reasons. For example, the wireless communication may be turned off by setting a flight mode, disabling/changing a subscriber identity module (SIM) card, disabling an embedded SIM (eSIM) profile, low battery, or the like. In this case, the user may not receive or send a call/message over a network, which may result in missing an urgent call from a family member or a close friend. Call results may remain continuous failures even in a case that a mobile origination (MO) displays the call as the urgent call by using its display function as the urgent call.

### SUMMARY

According to an aspect of the disclosure, an electronic apparatus includes: a communication interface; at least one memory for storing at least one instruction; and at least one processor operatively connected to the communication interface and the at least one memory, and configured to execute the at least one instruction to: identify a wireless connection state of a user terminal based on information on the wireless connection state of the user terminal in a case that an urgent call event to the user terminal occurs, transmit a wireless connection enable request to a server, through the communication interface, by using a predetermined existing connection, based on identifying that the wireless connection state of the user terminal is a disable state, and transmit an urgent call to the user terminal in a case that: the at least one processor receives a response signal from the user terminal enabling its wireless connection after receiving the wireless connection enable request from the server, or a predetermined time elapses.

According to an aspect of the disclosure, a user terminal includes: a communication interface; at least one memory for storing at least one instruction; and at least one processor connected to the communication interface and the at least one memory, and configured to execute the at least one instruction to: transmit, to a server, emergency contact information comprising identification information and a wireless connection state through the communication interface, and enable a wireless connection, and transmit, to the server, a response signal to a wireless connection enable request based on receiving the wireless connection enable request for receiving an urgent call from the server.

According to an aspect of the disclosure, a method of an electronic apparatus, includes: identifying a wireless connection state of a user terminal based on information on the wireless connection state of the user terminal in a case that an urgent call event to the user terminal occurs; transmitting a wireless connection enable request to a server by using a predetermined existing connection in a case that the wireless connection state of the user terminal is identified as being a disable state; and transmitting an urgent call to the user terminal in a case that: a response signal is received from the user terminal enabling its wireless connection by receiving the wireless connection enable request from the server, or a predetermined time elapses.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1, 2A, and 2B illustrate cases where urgent call reception is impossible;

FIG. 3 illustrates a schematic operation according to one or more embodiments;

FIG. 4 illustrates an operation between a mobile origination (MO) device, a server, and a mobile termination (MT) device according to one or more embodiments;

FIG. 5A illustrates a configuration of an electronic apparatus (the MO device) according to one or more embodiments;

FIG. 5B illustrates a configuration of the server according to one or more embodiments;

FIG. 5C illustrates showing a configuration of a user terminal (the MT device) according to one or more embodiments;

FIG. 6A illustrates an operation of an electronic apparatus according to one or more embodiments;

FIG. 6B illustrates operations performed by a user terminal according to one or more embodiments;

FIG. 7 illustrates a method of updating an emergency contact list according to one or more embodiments;

FIG. 8 illustrates a method of updating the emergency contact list according to one or more embodiments;

FIG. 9 illustrates a form of data stored in the server according to one or more embodiments;

FIG. 10 illustrates a form of data stored in a MO device according to one or more embodiments;

FIGS. 11A and 11B illustrate a method of updating an MT state according to one or more embodiments;

FIG. 12 illustrates a method of transmitting an urgent call according to one or more embodiments;

FIG. 13 illustrates operations of the MO device, the server, and the MT device according to one or more embodiments;

FIGS. 14 and 15 illustrates a method of transmitting a message through a nearby device according to one or more embodiments;

FIG. 16 illustrates a method of providing the urgent call to an unauthenticated device according to one or more embodiments;

FIG. 17 illustrates a method of making an MO route call to an alternative number according to one or more embodiments; and

FIG. 18 illustrates a method of remotely enabling wireless connection of the MT device according to one or more embodiments.

### DETAILED DESCRIPTION

Terms used in the specification are briefly described, and the disclosure is then described in detail.

General terms currently widely used are selected as terms used in embodiments of the disclosure in consideration of their functions in the disclosure, and may be changed based on the intentions of those skilled in the art or a judicial precedent, the emergence of a new technique, or the like. In addition, in a specific case, terms arbitrarily chosen by an applicant may exist. In this case, the meanings of such terms are mentioned in detail in corresponding description portions of the disclosure. Therefore, the terms used in the disclosure need to be defined on the basis of the meanings of the terms and the contents throughout the disclosure rather than simple names of the terms.

In the disclosure, an expression “have”, “may have”, “include”, “may include”, or the like, indicates the existence of a corresponding feature (for example, a numerical value, a function, an operation, or a component such as a part), and does not exclude the existence of an additional feature.

In the disclosure, an expression “A or B”, “at least one of A and/or B”, “one or more of A and/or B”, or the like, may include all possible combinations of items enumerated together. For example, “A or B”, “at least one of A and B” or “at least one of A or B” may indicate all of 1) a case where at least one A is included, 2) a case where at least one B is included, or 3) a case where both of at least one A and at least one B are included.

Expressions “first”, “second”, and the like, used in the specification may qualify various components regardless of the sequence or importance of the components. The expression is used only to distinguish one component from another component, and does not limit the corresponding component.

In a case that any component (for example, a first component) is mentioned to be “(operatively or communicatively) coupled with/to” or “connected to” another component (for example, a second component), it is to be understood that any component may be directly coupled to another component or may be coupled to another component through still another component (for example, a third component).

An expression “configured (or set) to” used in the disclosure may be replaced by an expression “suitable for”, “having the capacity to”, “designed to”, “adapted to”, “made to” or “capable of” based on a situation. The expression “configured (or set) to” may not necessarily indicate “specifically designed to” in hardware.

Instead, an expression “a device configured to” in a certain situation may indicate that the device may “perform˜” together with another device or component. For example, “a processor configured (or set) to perform A, B and C” may indicate a dedicated processor (for example, an embedded processor) that may perform the corresponding operations or a generic-purpose processor (for example, a central processing unit (CPU) or an application processor) that may perform the corresponding operations by executing one or more software programs stored in a memory device.

A term of a single number may include its plural number unless explicitly indicated otherwise in the context. It is to be understood that a term “include”, “formed of”, or the like used in the application specifies the presence of features, numerals, steps, operations, components, parts, or combinations thereof, mentioned in the specification, and does not preclude the presence or addition of one or more other features, numerals, steps, operations, components, parts, or combinations thereof.

In the embodiments, a “module” or a “˜er/or” may perform at least one function or operation, and be implemented in hardware or software, or be implemented by a combination of hardware and software. In addition, a plurality of “modules” or a plurality of “˜ers/˜ors” may be integrated in at least one module to be implemented by at least one processor except for a “module” or a “˜er/or” that needs to be implemented by specific hardware.

Various elements and regions in the drawings are schematically shown. Therefore, the spirit of the disclosure is not limited by relative sizes or intervals shown in the accompanying drawings.

Hereinafter, an embodiment of the disclosure is described in more detail with reference to the accompanying drawings.

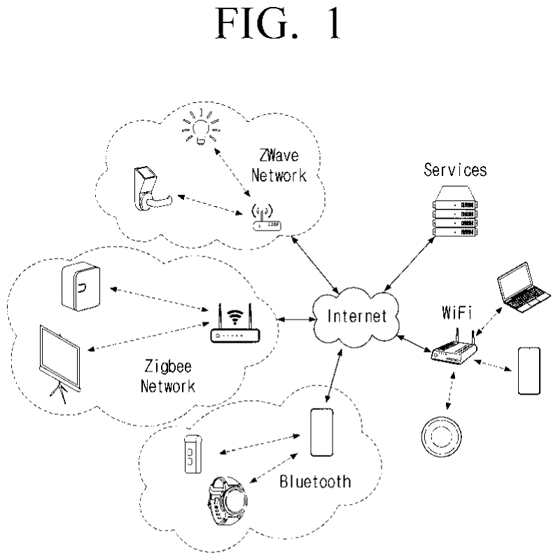

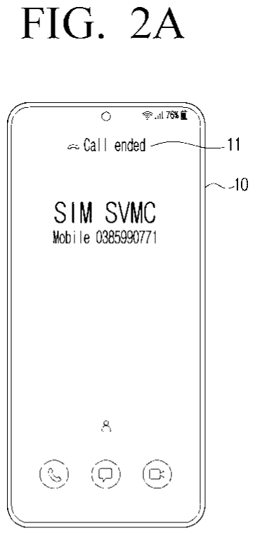

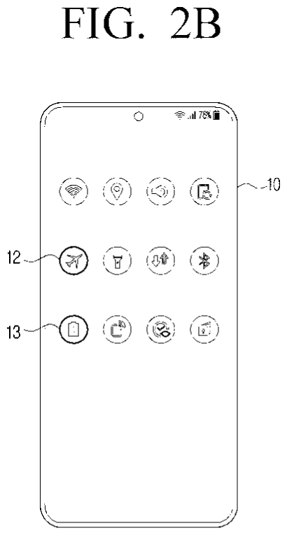

FIGS. 1, 2A, and 2B illustrate a case where urgent call reception is impossible.

As shown in FIG. 1, internet of things (IoT) devices may have a rapidly increasing number, thus allowing communication to be performed in various ways through an IoT network. For example, various electronic devices may be connected to each other through the IoT network to thus exchange data and provide various functions. For example, the electronic devices may store the data on an internet server such as a cloud, and provide a user with an optimized function based thereon.

FIG. 2A illustrates a subscriber identity module (SIM) card/embedded SIM (eSIM) disable state according to an example.

In an example, a call/SMS may not be provided to the user in a case that the physical SIM card of a wireless terminal 10 is disabled or the eSIM profile is disabled.

FIG. 2B illustrates a case where the wireless terminal 10 is set to a do not disturb mode, a flight mode, or a low power mode, according to an example.

The call/SMS may no longer be provided to the user in a case that the wireless terminal 10 is set to the do not disturb mode, a flight mode 12 or a low power mode 13. For example, the wireless terminal 10 may still maintain wireless connection with the network, and a mobile origination (MO) device (or “MO”) may still communicate with a mobile termination (MT) device (or “MT”). However, the user may not accept the call unless the mode, such as ‘do not disturb mode’, is turned off. The MO device may transmit the call, e.g., short message service (SMS)/multimedia messaging service (MMS) message, to a specific server. In this case, the server may receive the message and transmit the same to the MT device. Here, the MO device may be a device that transmits an urgent call, and the MT device may be a device that receives the urgent call.

In an example, the wireless connection of the wireless terminal 10 may be disconnected and still connected to a wireless-fidelity (WiFi) network. In this case, the MO device may access the MT device by using a third party application (3^{rd} party app). However, this case may cause call quality and/or security issues.

The following description describes one or more embodiments where the MO device is able to make the urgent call to the MT device even in a state where the MT is unable to perform the wireless communication based on an IoT environment.

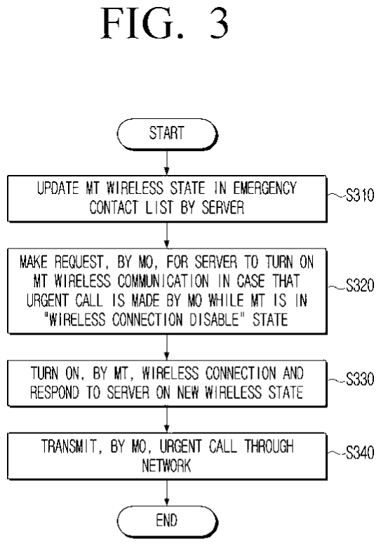

FIG. 3 illustrates operations for transmitting an urgent call from the MO to the MT, according to one or more embodiments.

According to an embodiment shown in FIG. 3, a wireless state (or wireless communication state) of the MT device may be updated in an emergency contact list by the server (S310). Here, the MT device may include a call module supporting the urgent call (e.g., call information included in an urgent call type and/or an urgent call option selected by the user). Here, the urgent call may include an urgent call of a family member or a close friend. However, the disclosure is not limited thereto, and the urgent call type may also include various urgent texts such as a disaster text and an accident text.

Next, the MO device may make a request for the server to turn on the wireless communication of the MT device in a case that the MO device makes the urgent call when the MT device is in a “wireless connection disable” state (S320). For example, the MO device may transmit a request message for wireless connection enable of the MT device to a public server.

Next, the MT may turn on the wireless connection and respond to the server on its new wireless state (S330).

The MO device may then transmit the urgent call through the network (S340). For example, the MO device may transmit the urgent call through the network in case of (based on) receiving a response to the wireless connection enable of the MT device, or a timer T expires.

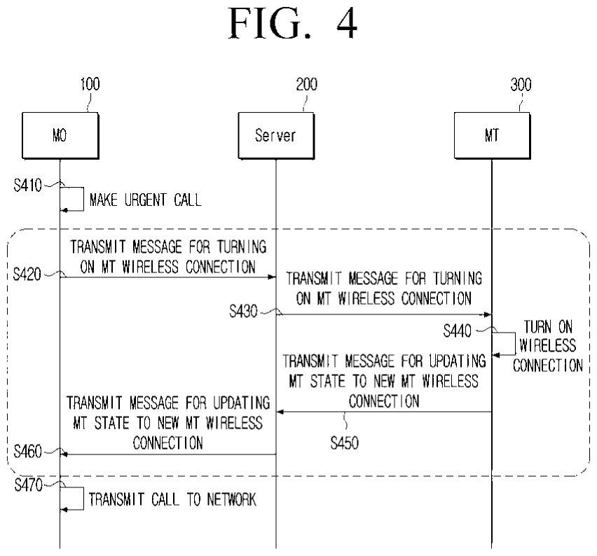

FIG. 4 illustrates operations among an MO device 100, a server 200, and an MT device 300, according to one or more embodiments. Throughout the disclosure, the MO device 100 is also referred to as an electronic apparatus 100 and the MT device 300 is also referred to as an user terminal 300.

In FIG. 4, the MO device 100 may transmit a message (or a request) for turning on wireless connection of the MT device 300 to the server 200 (S420) in a case that the MO device 100 makes an urgent call (S410).

The server 200 may transmit the message for turning on the wireless connection of the MT device 300 to the MT device 300 (S430).

The MT device 300 may turn on the wireless connection based on the message received from the server 200 (S440), and transmit a message for updating an MT state to a new MT wireless connection to the server 200 (S450).

The server 200 may transmit the message for updating the MT state to the new MT wireless connection to the MO device 100 based on the message received from the MT device 300 (S460).

The MO device 100 may transmit the call to the network based on the message received from the server 200 (S470).

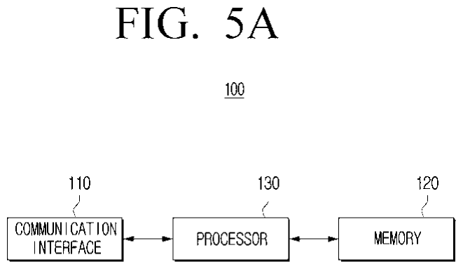

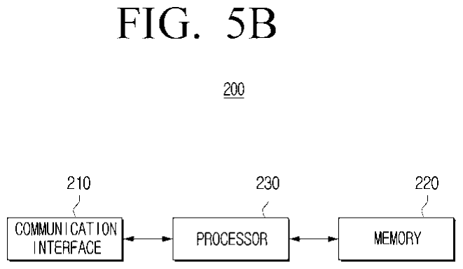

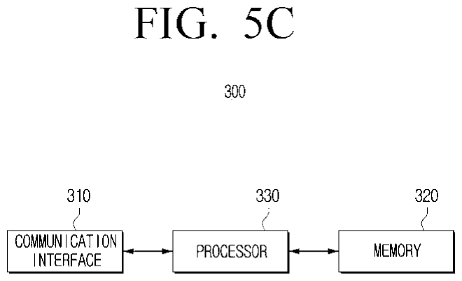

FIG. 5A illustrates a configuration of an electronic apparatus 100 (the MO device 100) according to one or more embodiments.

According to an embodiment, the electronic apparatus 100 may include a communication interface 110, a memory 120 (at least one memory), and at least one processor 130.

The electronic apparatus 100 may be implemented as various apparatuses having a wireless communication function, such as a smartphone, a tablet personal computer (PC), a smart television (TV), an electronic picture frame, an electronic blackboard, an electronic table, a laptop computer, a digital signage, a digital information display (DID), a video wall, and a projector. In an example, the electronic apparatus 100 may be implemented as the MO device 100.

The communication interface 110 may be implemented as various interfaces based on an implementation example of the electronic apparatus 100. For example, the communication interface 110 may communicate with an external device by using a communication method such as a cellular communication, a Bluetooth™, an access point (AP)-based WiFi (or a local area network (LAN) network), a Zigbee, a wired/wireless LAN, a wide area network (WAN), Ethernet, an IEEE 1394, a high definition multimedia interface (HDMI), an universal serial bus (USB), a mobile high-definition link (MHL), an audio engineering society/European broadcasting union (AES/EBU) communication, an optical communication, or a coaxial communication.

The memory 120 may store data necessary for the one or more embodiments. The memory 120 may be implemented in the form of a memory embedded in the electronic apparatus 100 or in the form of a memory detachable from the electronic apparatus 100, based on a data storage purpose. For example, data for driving the electronic apparatus 100 may be stored in a memory embedded in the electronic apparatus 100, and data for an extension function of the electronic apparatus 100 may be stored in the memory detachable from the electronic apparatus 100. In some embodiments, the memory embedded in the electronic apparatus 100 may be implemented as at least one of a volatile memory (for example, a dynamic random access memory (DRAM), a static RAM (SRAM), or a synchronous dynamic RAM (SDRAM)), or a non-volatile memory (for example, an one time programmable read only memory (OTPROM), a programmable ROM (PROM), an erasable and programmable ROM (EPROM), an electrically erasable and programmable ROM (EEPROM), a mask ROM, a flash ROM, a flash memory (for example, a NAND flash or a NOR flash), a hard drive, or a solid state drive (SSD)). In addition, a memory detachable from the electronic apparatus 100 may be implemented in the form of a memory card (for example, a compact flash (CF), a secure digital (SD), a micro secure digital (Micro-SD), a mini secure digital (Mini-SD), an extreme digital (xD), or a multi-media card (MMC)), or an external memory which may be connected to a USB port (for example, a USB memory).

At least one processor 130 may control overall operations of the electronic apparatus 100. In detail, at least one processor 130 may be connected to each component of the electronic apparatus 100 to thus control the overall operations of the electronic apparatus 100. For example, at least one processor 130 may be electrically connected to the communication interface 110 and the memory 120, and control the overall operations of the electronic apparatus 100. The processor 130 may be at least one processor.

At least one processor 130 may perform the operation of the electronic apparatus 100 according to the one or more embodiments by performing at least one instruction stored in the memory 120.

At least one processor 130 may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. At least one processor 130 may control one of other components of the electronic apparatus or any combination thereof, and perform an operation related to communication or data processing. At least one processor 130 may execute at least one program or instruction stored in the memory. For example, at least one processor may perform a method according to one or more embodiments of the disclosure by executing at least one instruction stored in the memory.

The plurality of operations may be performed by one processor or may be performed by the plurality of processors in a case that the method according to one or more embodiments of the disclosure includes the plurality of operations. For example, a first operation, a second operation, and a third operation may be performed by the method according to one or more embodiments. In this case, the first operation, the second operation, and the third operation may all be performed by a first processor. Alternatively, the first operation and the second operation may be performed by the first processor (for example, a general-purpose processor), and the third operation may be performed by a second processor (for example, an artificial intelligence-only processor).

At least one processor 130 may be implemented as a single-core processor including a single core, or may be implemented as at least one multi-core processor including multi cores (for example, homogeneous multi cores or heterogeneous multi cores). In a case that at least one processor 130 is implemented as the multi-core processor, each of the multi cores included in the multi-core processor may include a processor internal memory such as a cache memory or an on-chip memory, and a common cache shared by the multi cores may be included in the multi-core processor. In addition, each (or some) of the multi cores included in the multi-core processor may independently read and perform a program instruction for implementing the method according to one or more embodiments of the disclosure, or all (or some) of the multi cores may be linked with each other to read and perform the program instruction for implementing the method according to one or more embodiments of the disclosure.

In a case that the method according to one or more embodiments of the disclosure includes the plurality of operations, the plurality of operations may be performed by one core among the multi cores included in the multi-core processor, or may be performed by the multi cores. For example, in a case that the first operation, the second operation, and the third operation are performed by the method according to one or more embodiments, the first operation, the second operation, and the third operation may all be performed by a first core included in the multi-core processor. Alternatively, the first operation and the second operation may be performed by the first core included in the multi-core processor, and the third operation may be performed by a second core included in the multi-core processor.

In the embodiments of the disclosure, the processor may indicate a system-on-chip (SoC) in which at least one processor and other electronic components are integrated, the single-core processor, the multi-core processor, or the core included in the single-core processor or the multi-core processor. Here, the core may be implemented as the CPU, the GPU, the APU, the MIC, the DSP, the NPU, the hardware accelerator, the machine learning accelerator, or the like. However, the embodiments of the disclosure are not limited thereto. Hereinafter, for convenience of description, at least one processor 130 is referred to as the processor 130.

FIG. 5B illustrates a configuration of the server according to one or more embodiments.

According to an embodiment, the server 200 may include a communication interface 210, a memory 220 (at least one memory), and at least one processor 230 (at least one processor). An implementation form of the communication interface 210, the memory 220, or at least one processor 230 is the same or similar to that of the communication interface 110, the memory 120, or at least one processor 130, included in the electronic apparatus 100, and the description thus omits its detailed description.

FIG. 5C illustrates a configuration of a user terminal 300 (the MT device 300) according to one or more embodiments.

The user terminal 300 may be implemented as the various apparatuses having the wireless communication function, such as the smartphone, the tablet personal computer (PC), the smart television (TV), the electronic picture frame, the electronic blackboard, the electronic table, the laptop computer, the digital signage, the digital information display (DID), the video wall, or the projector. In an example, the user terminal 300 may be implemented as the MT device 300.

According to an embodiment, the user terminal 300 may include a communication interface 310, a memory 320, and at least one processor 330. An implementation form of the communication interface 310, the memory 320, or at least one processor 330 is the same or similar to that of the communication interface 110, the memory 120, or at least one processor 130, included in the electronic apparatus 100, and the description thus omits its detailed description.

According to one or more embodiments, a function performed by the electronic apparatus 100, the server 200, or the user terminal 300 may be performed through the processor 130, 230, or 330. However, hereinafter, for convenience of description, the description describes that this function is performed by the electronic apparatus 100, the server 200, or the user terminal 300.

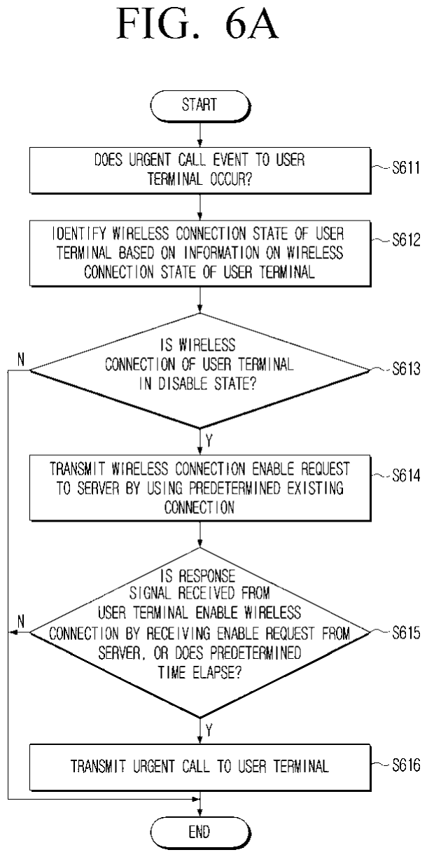

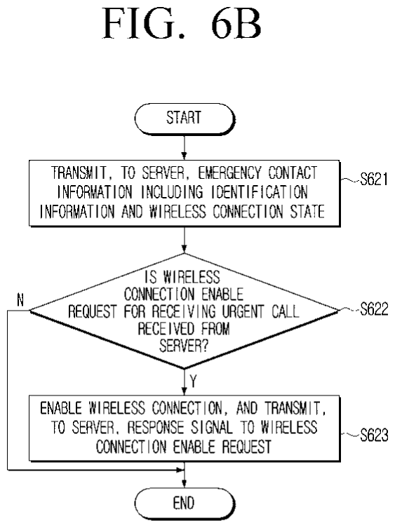

FIG. 6A illustrates operations performed by the electronic apparatus 100 according to one or more embodiments.

According to the embodiment shown in FIG. 6A, the electronic apparatus 100 may identify a wireless connection state of the user terminal 300 based on information on the wireless connection state of the user terminal 300 (S612) in a case that an urgent call event to the user terminal 300 occurs (S611—Y). The information on the wireless connection state of the user terminal 300 may include the wireless connection state of the user terminal 300 and a reason for disabling the wireless connection.

The electronic apparatus 100 may transmit a wireless connection enable request to the server 200 by using a predetermined existing connection (S614) in case of (based on) identifying that the wireless connection of the user terminal 300 is in a disable state (S613—Y). The wireless connection enable request may correspond to a request for enabling wireless connection of the MT device 300

In an example, the wireless connection may include a cellular communication (or mobile communication) connection. For example, the predetermined existing connection may include at least one of an internet connection or a nearby connection. For example, the nearby connection may include at least one of Bluetooth low energy (BLE), ‘Nearby Share’ (by Google), or ‘Quick Share’ (by Samsung).

The electronic apparatus 100 may transmit the urgent call to the user terminal (S616) in a case that the electronic apparatus 100 receives a response signal from the user terminal 300 or a predetermined time elapses (S615—Y). In this case, the user terminal 300 may enable its wireless connection by receiving the wireless connection enable request from the server 200, and then, transmit the response signal to the server 200.

In an example, the electronic apparatus 100 may transmit a request for updating the wireless connection state of the user terminal 300 to the server 200 to re-attempt the urgent call in case of identifying that the urgent call is not transmitted to the user terminal 300.

In an example, the electronic apparatus 100 may update the wireless connection state of the user terminal 300 in the memory 120 in case of receiving identification information of the user terminal 300 and the information on the wireless connection state of the user terminal 300. For example, the electronic apparatus 100 may update the identification information of the user terminal 300 and the information on the wireless connection state of the user terminal 300 in the emergency contact list.

In an example, the electronic apparatus 100 may transmit the urgent call to the user terminal 300 based on received alternative identification information in case of receiving the alternative identification information of the user terminal 300 from the server 200 in response to the request for updating the wireless connection state of the user terminal 300.

FIG. 6B illustrates operations performed the user terminal 300 (the MT device 300) according to one or more embodiments.

According to the embodiment shown in FIG. 6B, the user terminal 300 may transmit, to the server 200, emergency contact information including the identification information and the wireless connection state (S621). For example, the emergency contact information may include the wireless connection state of the user terminal 300 and the reason for disabling the wireless connection.

The user terminal 300 may enable the wireless connection, and transmit, to the server 200, the response signal to the wireless connection enable request (S623) in case of receiving the wireless connection enable request for receiving the urgent call from the server 200 (S622—Y). In an example, the user terminal 300 may enable the wireless connection through at least one of flight mode turn off, SIM card turn on, or eSIM profile turn on.

In an example, the user terminal 300 may notify the server 200 that the user terminal 300 is in a ready state for the urgent call reception in case of enabling the wireless connection and then successfully performing the cellular communication (or mobile communication).

In an example, the user terminal 300 may attempt to camp using ‘voice-over-WiFi’ (VoWiFi) in case of enabling the wireless connection and then failing to perform the cellular communication, and notify the server 200 that the user terminal 300 is in the ready state for the urgent call reception in case of successfully camping using the VoWiFi. Attempting to camp using the VoWiFi may indicate attempting to route the call through a WiFi network.

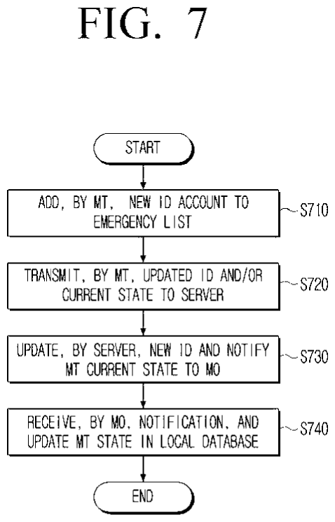

FIG. 7 illustrates a method of updating the emergency contact list according to one or more embodiments.

According to the embodiment shown in FIG. 7, the MT device 300 may add a new identity (ID) account to the emergency contact list (S710). Here, the ID is information for identifying the MT device 300, may be at least one of a specific account, for example, Samsung account/Google account, phone number, or international mobile equipment identity (IMEI), and is not limited thereto.

The MT device 300 may transmit an updated ID and/or a current state to the server 200 (S720). For example, the wireless connection state of the MT device 300 may be changed. In this case, the MT device 300 may transmit the updated ID and/or the current state to the server 200 through the internet connection and/or the nearby connection. In addition, the MT device 300 may transmit, to the server 200, the reason why the wireless connection is unable to be used (for example, the flight mode/the SIM card disable).

The server 200 may update the new ID received from the MT device 300 and notify the current state of the MT device 300 to the MO device 100 (S730). For example, the server 200 may check the ID registered for an urgent call service, and share the updated MT state of the registered MO ID.

The MO device 100 may receive the notification from the server 200, and update the state of the MT device 300 in a local database (S740).

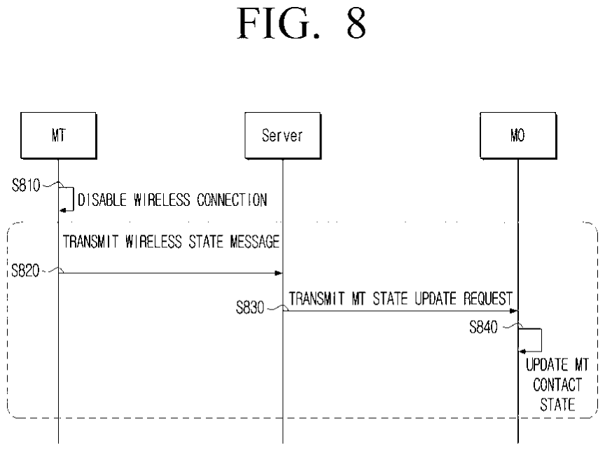

FIG. 8 illustrates a method of updating the emergency contact list according to one or more embodiments.

According to the embodiment shown in FIG. 8, the MT device 300 may transmit a wireless state message to the server 200 (S820) in a case that its wireless connection is disable (S810). For example, the wireless state message may include information indicating that the wireless connection of the MT device 300 is in the disable state and a reason for the disabling.

The server 200 may make an MT state update request to the MO device 100 based on the wireless state message received from the MT device 300 (S830). Here, the MT state update request may include information indicating that the wireless connection of the MT device 300 is in the disable state and the reason for the disabling.

The MO device 100 may update an MT contact state based on the MT state update request received from the server 200 (S840). For example, the MO device 100 may update the fact that the wireless connection of MT device 300 is in the disable state and the reason for the disabling in the pre-stored emergency contact list.

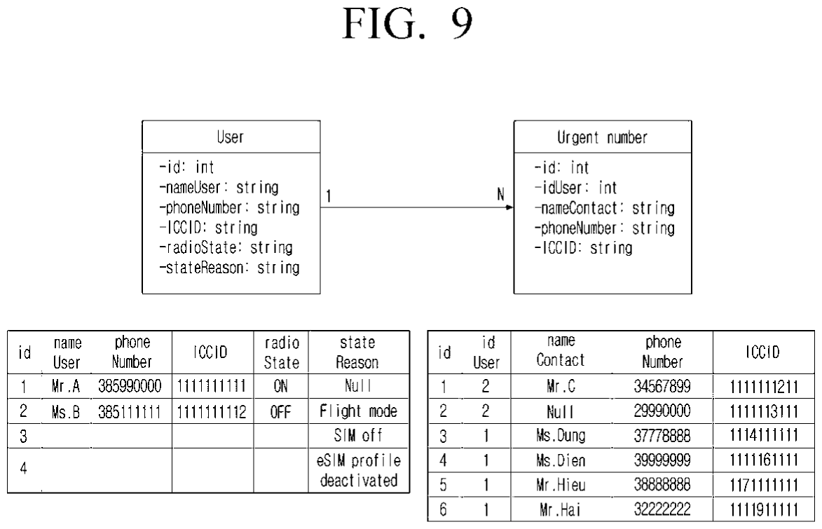

FIG. 9 illustrates a form of data stored in the server 200 according to one or more embodiments.

According to one or more embodiments, as shown in FIG. 9, the data stored in the memory 220 of the server 200 may have a form of at least one urgent number information corresponding to user information. For example, “N” urgent number information for one piece user information may be mapped and stored. “N” is an integer larger than zero (0).

As shown on a left side of FIG. 9, the user information may include id, nameUser, phoneNumber, integrated circuit card identifier (ICCID), radioState, and stateReason. As shown on a right side of FIG. 9, the urgent number information may include id, idUser, nameContact, phoneNumber, and ICCID.

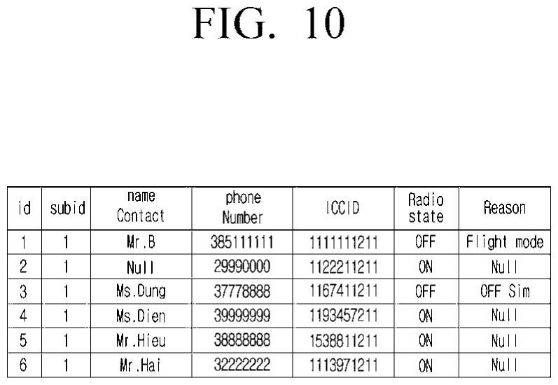

FIG. 10 illustrates a form of data stored in the MO device 100 according to one or more embodiments.

According to one or more embodiments, as shown in FIG. 10, the data may include id, subid, phoneNumber, ICCID, radioState, and stateReason.

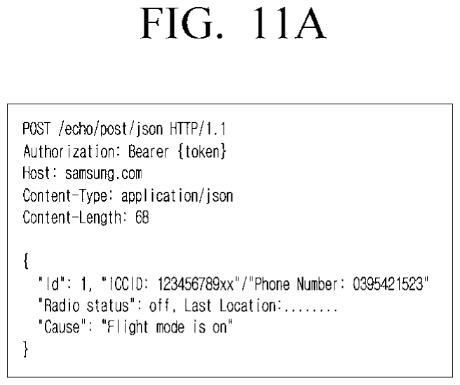

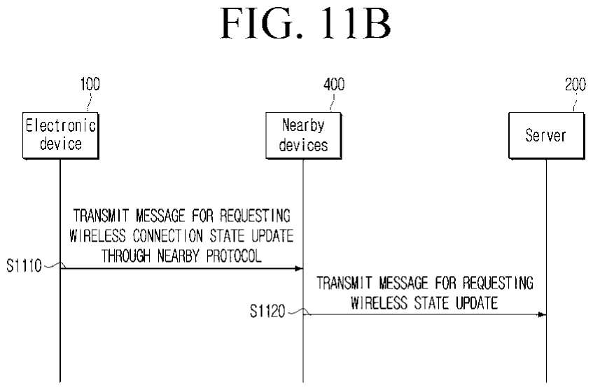

FIGS. 11A and 11B illustrate a method of updating the MT state according to one or more embodiments.

According to one or more embodiments, the wireless state message of the MT device 300 may be updated by the internet connection. For example, as shown in FIG. 11A, updating the message may have a form of hypertext transfer protocol post office serial transmission (HTTP POST), hypertext transfer protocol put up transmission (HTTP PUT), or the like.

According to one or more embodiments, the wireless state message of the MT device 300 may be updated by nearby connection. For example, as shown in FIG. 11A, the updating message may be transmitted through the nearby device. For example, as shown in FIG. 11B, the electronic apparatus 100 may transmit the message for requesting the wireless state update of the MT device 300 through a nearby protocol to the nearby device (S1110). In this case, the nearby device 400 may transmit the message for requesting the wireless state update of the MT device 300 to the server 200 (S1120).

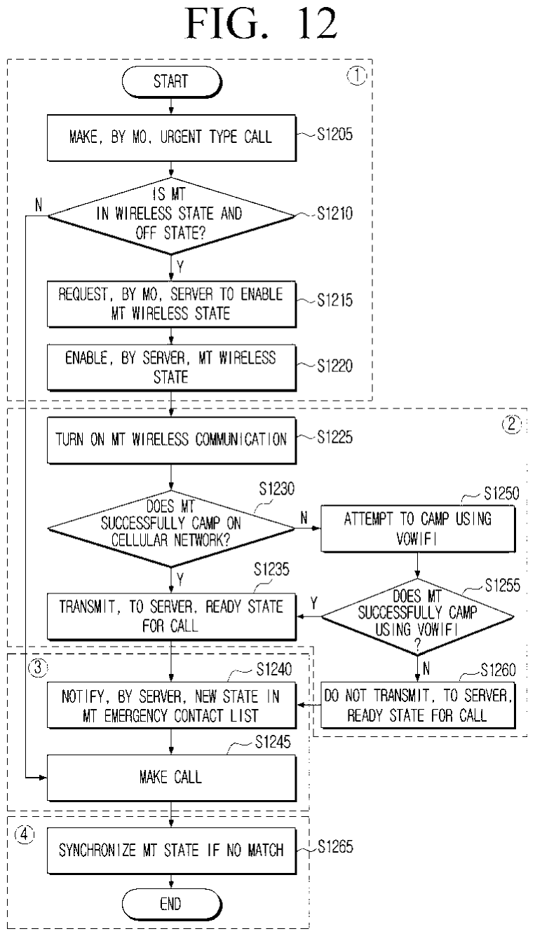

FIG. 12 illustrates a method of transmitting the urgent call according to one or more embodiments.

According to the embodiment shown in FIG. 12, the MO device 100 may make an urgent type call based on an event (S1205). Here, the urgent call type may include the urgent call of the family member or the close friend. However, the urgent call type is not limited thereto, and may also include various urgent texts such as the disaster text and the accident text.

The MO device 100 may request the server 200 to enable the wireless state of the MT device 300 (S1215) in case of identifying that the MT device 300 is in the wireless state and in an off state (or turn-off state) (S1210—Y). For example, the fact that the MT device 300 is in the wireless state and is in the off state may indicate that the cellular communication is in the off state for a specific reason although the MT device 300 supports the cellular communication. For example, the MT device 300 may turn off the cellular communication by the physical SIM card disable, the eSIM profile disable, the do not disturb mode, the flight mode, and/or the low power mode.

The server 200 may enable the wireless state of the MT device 300 (S1220). For example, the server 200 may enable the wireless state of the MT device 300 based on various methods such as the WiFi, the BLE, the nearby device, an IoT system, or the like (S1220).

It may be identified whether the MT device 300 successfully camps on a cellular network (S1230) in a case that the wireless communication of the MT device 300 is turned on (S1225).

The MT device 300 may transmit, to the server 200, its ready state for the call (S1235) in case of successfully camps on the cellular network (S1230—Y).

The server 200 may update the new state of the MT device 300 in the emergency contact list and/or notify the MO device 100 of the updated state (S1240). For example, the server 200 may update the new state of the MT device 300 in the pre-stored emergency contact list and notify the MO device 100 of the updated state.

In this case, the MO device 100 may transmit a call request made by the cellular network (S1245).

The MT device 300 may attempt to camp on the WiFi network, by using ‘VoWifi’, for example (S1250) in case of failing to successfully camp on the cellular network (S1230-N). The VoWiFi is a technology related to “WiFi call” that may use a home WiFi network for the call.

The server 200 may notify the new state as the emergency contact list of the MT device 300 (S1235) in a case that the MT device 300 successfully camps using the VoWifi (S1255—Y).

The MT device 300 may not transmit, to the server 200, the ready state for the call (S1260) in case of failing to camp successfully using the VoWifi (S1255-N). In this case, the server 200 may notify the new state as the emergency contact list of the MT device 300 (S1240).

In some embodiments, the MT state may be synchronized (or re-synchronized), if necessary (S1265). For example, the MT state may be synchronized (or re-synchronized) in a case that the new state of the MT device 300 does not match its pre-stored state.

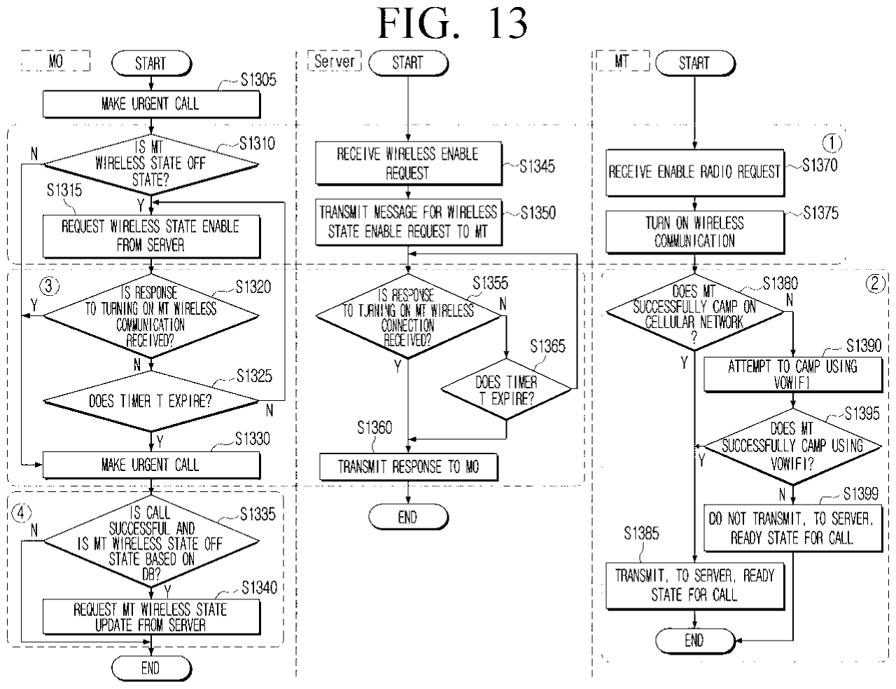

FIG. 13 illustrates operations performed by the MO device, the server, and the MT device according to one or more embodiments.

Referring to FIG. 13, the MO device 100 may identify whether the wireless state of the MT device 300 is the off state (S1310) in case of making the urgent call (S1305).

The MO device 100 may transmit the wireless state enable request to the server 200 (S1315) in a case that the wireless state of the MT device 300 is the off state (S1310—Y). The wireless state enable request may correspond to a request for turning on wireless state (communication) of the MT device 300.

The MO device 100 may make the urgent call (S1330) in case of receiving a response to turning on the wireless communication of the MT device 300 (S1320—Y).

The MO device 100 may identify whether the timer T expires (S1325) in case of receiving no response to turning on the wireless communication of the MT device 300 (S1320—N). Here, the timer T may be set to a predefined timer time at a time point of transmitting the wireless state enable request.

The MO device 100 may make the urgent call (S1330) in a case that the timer T expires (S1325—Y).

The MO device 100 may request the wireless state update of the MT device 300 from the server 200 (S1340) in case of identifying that the wireless state of the MT device 300 is the off state based on the database although the call is successful (S1335—Y).

The server 200 may transmit the message for the wireless state enable request to the MT device 300 (S1350) in a case that the server 200 receives the request for the wireless enable of the MT device 300 (S1345). For example, the server 200 may transmit the request message to the MT device 300 through the WiFi and/or the BLE.

The server 200 may transmit the response to the MO device 100 (S1360) in case of receiving the response to turning on the MT wireless connection (S1355—Y).

The server 200 may transmit the response to the MO device 100 (S1360) in a case that the server 200 receives no response to turning on the MT wireless communication (S1355—N), and the timer T expires (S1365—Y).

The MT device 300 may turn on the wireless communication (S1375) in case of receiving the message for the wireless enable request (S1370—Y).

The MT device 300 may transmit, to the server 200, the ready state for the call (S1385) in case of successfully camping on the cellular network (S1380—Y).

The MT device 300 may attempt to camp using the VoWifi (S1390) in case of failing to successfully camp on the cellular network (S1380—N).

The MT device 300 may transmit the ready state for the call to the server 200 (S1385) in case of successfully camping using the VoWifi (S1395—Y).

The MT device 300 may not transmit, to the server 200, the ready state for the call (S1399) in case of failing to successfully camping using the VoWifi (S1395—N).

In FIG. 13, block For example “(1)” (circled one) is a block for describing making the wireless connection enable request. In an example, the block “(1)” (circled one) may be responsible for enabling the wireless connection and reporting the ready state of the MT for the MO. In case of making the urgent call, the MO may check the MT number in a current database, and synchronize the local database on the server 200. The MO may start a wireless connection enable process in a case that the MT is in the wireless communication disable state for a certain reason. Otherwise, the call may be transmitted immediately to a core network.

In FIG. 13, block “(2)” (circled two) is a block for describing enabling the wireless connection of the MT. In an example, the block “(2)” (circled two) may be responsible for enabling the wireless connection and reporting the ready state of the MT for the MO. In an example, the MT may perform the wireless power turn on/the selected SIM/profile enable in case of receiving the message from the server 200, and the MT may attempt to camp on the network in various ways, including the VoWiFi in preparation for a case that the MT is unable to be connected to the cellular network. The MT may report the ready state for receiving the call from the MO, and attempt to enable the wireless connection and camp on the network. Information on whether the wireless connection state is success/failure may be transmitted to the MO through the server 200 for further processing.

In FIG. 13, block “(3)” (circled three) is a block for describing reporting the MT state to the MO. In an example, block “(3)” (circled three) may be responsible for receiving the MT state and the urgent call. In an example, the server 200 may wait to receive the MT state after transmitting the wireless connection enable request within the timer T. The server 200 may transmit a result to the MO in a case that the MT state is capable of being updated on the server 200 within the timer T, and the server 200 may transmit a failure result to the MO in a case that the server 200 receives no response from the MT and the timer T expires. The MO may transmit the wireless connection enable request to the server 200, and then also start the timer T. The MO may process and transmit the call to the network in case of receiving the result within the timer T. That is, The MO may still transmit the call to the core network after the timer T expires even in case of receiving no response from the server 200.

In FIG. 13, block “(4)” (circled four) is a block for describing updating the new wireless state of the MT from the MO. In an example, block “(4)” (circled four) may be responsible for re-synchronizing the MT wireless state on the server. For example, in a case that the MO is yet to receive the MT state although making a successful urgent call, a synchronization request for the new MT state may be performed by the server 200, and this new state may be updated in the MO.

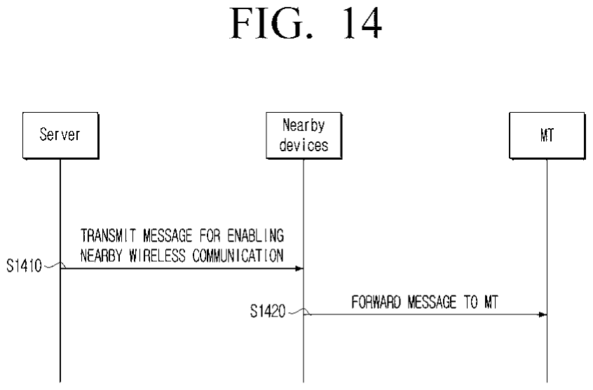

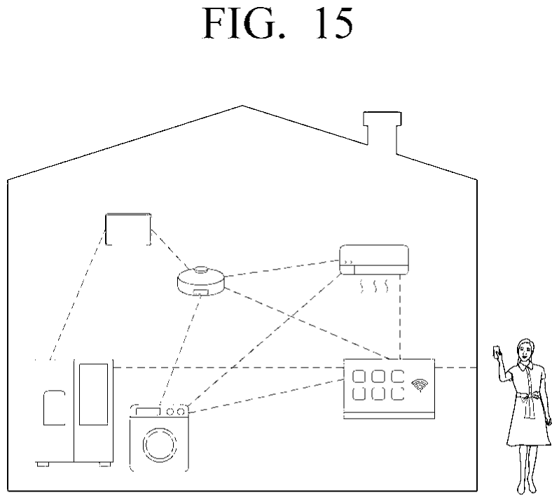

FIGS. 14 and 15 illustrate a method of transmitting the message through the nearby device according to one or more embodiments.

Referring to FIG. 14, the server 200 may transmit the message for enabling the wireless communication to the nearby device 400 (S1410). For example, the server 200 may transmit the message to the nearby device 400 by a share/BLE system.

The nearby device 400 may forward the received message to the MT device 300 (S1420).

Referring to FIG. 15, the MT device 300 may be connected to a WiFi AP, and in this case, the server 200 may transmit the message directly to the MT device 300. However, in a case that only the ‘Nearby Share’/BLE system remains, the server 200 may transmit the message (or request) to the MT device 300 by using the nearby device.

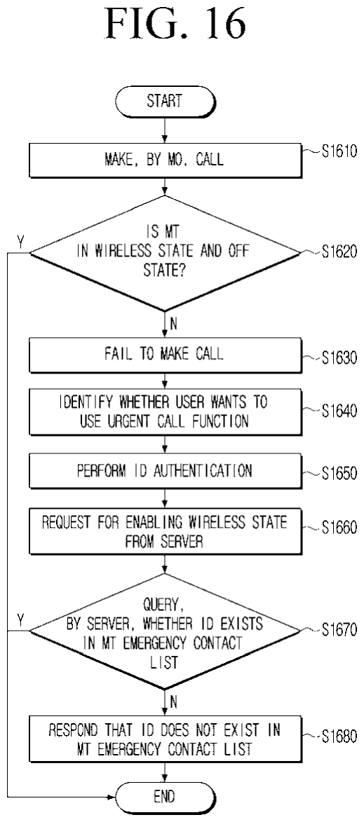

FIG. 16 illustrates a method of providing the urgent call to an unauthenticated device according to one or more embodiments.

Referring to FIG. 16, it may be identified whether the wireless state of the MT device 300 is the off state (S1620) in a case that the MO device makes the call (S1610).

It may be identified whether the user wants to use an urgent call function (S1640) in a case that the MT device 300 fails to make the call (S1630) although the wireless state of the MT device 300 is not the off state (S1620—N). For example, the user may change a user device to an unauthorized MO (for example, an MO determined by the ID). In this case, a call from this new MO to the MT device 300 may fail because these devices have no available connection therebetween.

In this case, the new MO requires a mechanism allowing the user to authenticate user ID to make the urgent call. Accordingly, the request for enabling the wireless connection of the MT device may be transmitted to the server 200. The request may include the ID account, an authentication state, the MT number, or the like.

The MO may perform ID authentication (S1650), and transmit the request for enabling the MT wireless state to the server 200 (S1660).

The server 200 may query whether the ID of the MO exists in the emergency contact list of the MT (S1670).

A process for enabling the wireless communication is the same as the process described above in a case that the ID of the MO exists in the emergency contact list of the MT (S1670—Y).

The MT may respond that the ID does not exist in its emergency contact list (S1680) in a case that the ID of the MO does not exist in the emergency contact list of the MT (S1670—N).

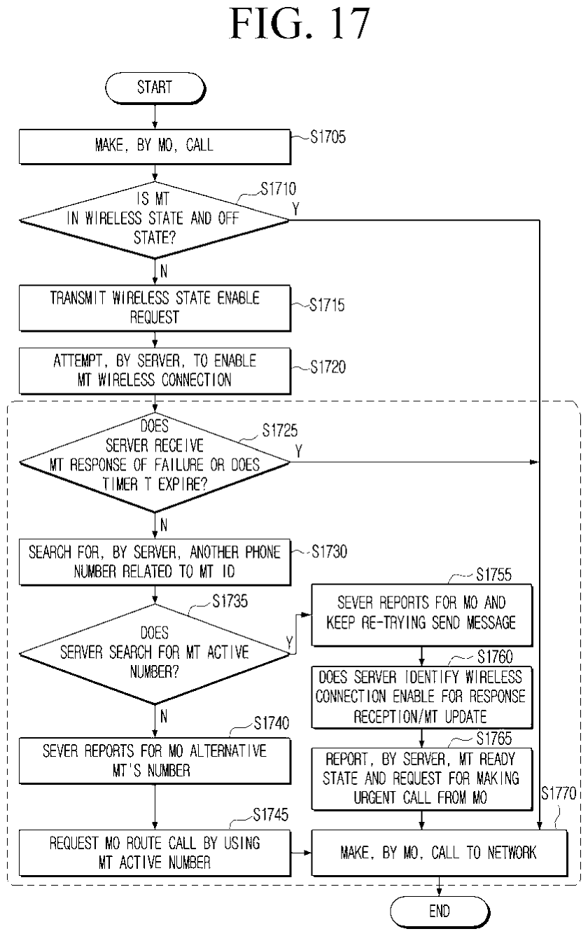

FIG. 17 illustrates a method of making an MO route call to an alternative number according to one or more embodiments.

In an example, one user may use a plurality of numbers, and these numbers may be linked to the user ID in a case that the user uses different IDs such as Google account, Samsung account, or IMEI. In this case, the server 200 may check a state of another alternative number if the server 200 fails to enable the number requested by the MO, and in a case that the server 200 finds another active number, the server 200 may transmit the corresponding number to the MO and request the MO to route the call to the new active number. This number may be linked to the ID, a state of the number may also be updated on the server 200.

Referring to FIG. 17, it may be identified whether the MT wireless state is the off state (S1710) in a case that the MO device 100 makes the call (S1705).

The MO device 100 may transmit the wireless state enable request to the server 200 (S1715) in a case that the MT wireless state is the off state.

The server 200 may attempt to enable the wireless connection of the MT device 300 (S1720).

The server 200 may search for another phone number related to the MT ID (S1730) in a case that the server 200 receives the MT response of failure or the timer T expires (S1725).

The server 200 may report an MT active number (or MT enable number) to the MO as an alternative MT number (S1740) in a case that the server 200 searches for the MT active number (S1735—Y).

The server 200 may request the MO route call by using the MT active number (S1745). In this case, the MO device 100 may make the call to the network (S1770).

The server 200 may report the result to the MO device 100 and maintain a message transmission reattempt (S1755) in case of failing to search for the MT active number (S1735—N). For example, the server 200 may retransmit an active message until receiving the response from the MT.

The server 200 may report the ready state of the MT to the MO device 100 and request for making the urgent call (S1765) in case of identifying the wireless connection enable for response reception/MT update (S1760). In this case, the MO device 100 may make the call to the network (S1770).

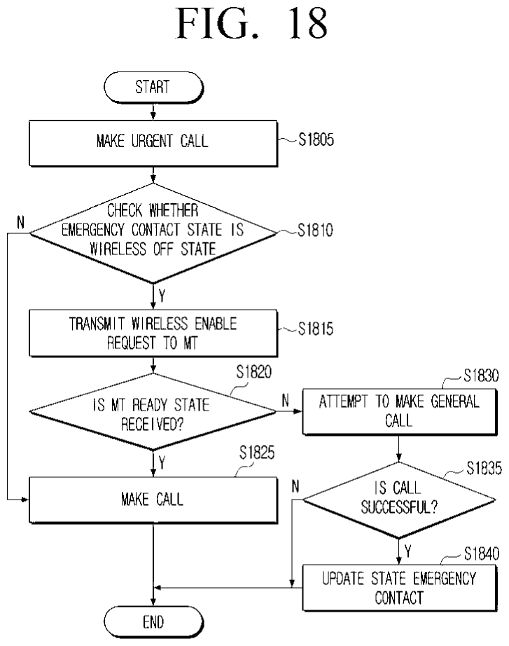

FIG. 18 illustrates a method of remotely enabling the wireless connection of the MT device according to one or more embodiments.

According to an embodiment, the MO device 100 may transmit the request for enabling the wireless connection of MT device 300 to the MT device in case of making the urgent call and detecting that the MT device 300 is in the wireless disable mode. The MO device 100 may then further proceed the urgent call process in a case that the MO device 100 receives the state of MT device 300 or the predetermined time elapses. The MO device 100 may perform a synchronization procedure if the state of the MT device 300 does not match a predetermined state.

According to an embodiment, another MO may also set the urgent call in a case that the new MO provides an authentication process.

According to an embodiment, the MO may be provided with the number of a new MT for the call, and receive a notification in a case that the MT is ready for the call.

Referring to FIG. 18, the MO device 100 may check whether the emergency contact state is a wireless off state (S1810) in case of making the urgent call (S1805).

The MO device 100 may transmit the wireless enable request to the MT device 300 (S1815) in a case that the emergency contact state is the wireless off state (S1810—Y).

The MO device 100 may make the call (S1825) in case of receiving that MT device 300 is in the ready state (S1820—Y).

The MO device 100 may attempt to make a general call (S1830) in case of failing to receive that the MT device 300 is in the ready state (S1820—N).

The MO device 100 may then update a state emergency contact (S1840) in case of successfully making the call (S1835).

According to the one or more embodiments described above, the MO may make the urgent call to the MT based on the IoT environment even in a state where the MT is unable to perform the wireless communication.

The methods according to the one or more embodiments of the disclosure described above may be implemented only by software upgrade or hardware upgrade of the conventional electronic apparatus.

In addition, the one or more embodiments of the disclosure described above may be performed through an embedded server disposed in the electronic apparatus, or a server disposed outside the electronic apparatus.

According to an embodiment of the disclosure, the one or more embodiments described above may be implemented in software including an instruction stored in a machine-readable storage medium (for example, a computer-readable storage medium). A machine may be an apparatus that invokes the stored instruction from the storage medium, may be operated based on the invoked instruction, and may include the electronic apparatus (e.g., electronic apparatus A) according to the disclosed embodiments. In a case that the instruction is executed by the processor, the processor may perform a function corresponding to the instruction directly or by using other components under control of the processor. The instruction may include a code provided or executed by a compiler or an interpreter. The machine-readable storage medium may be provided in the form of a non-transitory storage medium. Here, a term “non-transitory” may only indicate that the storage medium is tangible without including a signal, and does not distinguish whether data are semi-permanently or temporarily stored in the storage medium.

In addition, according to an embodiment of the disclosure, the methods in the one or more embodiments described above may be provided by being included in a computer program product. The computer program product may be traded as a product between a seller and a purchaser. The computer program product may be distributed in a form of the machine-readable storage medium (for example, a compact disc read only memory (CD-ROM)), or may be distributed online through an application store (for example, PlayStore™). In case of the online distribution, at least some of the computer program products may be at least temporarily stored in a storage medium such as a memory of a server of a manufacturer, a server of an application store, or a relay server, or be temporarily generated.

In addition, each of the components (for example, modules or programs) according to the one or more embodiments described above may include one entity or a plurality of entities, and some of the corresponding sub-components described above may be omitted or other sub-components may be further included in the one or more embodiments. Alternatively or additionally, some of the components (e.g., modules or programs) may be integrated into one entity, and may perform functions performed by the respective corresponding components before being integrated in the same or similar manner. Operations performed by the modules, the programs, or other components according to the one or more embodiments may be executed in a sequential manner, a parallel manner, an iterative manner, or a heuristic manner, at least some of the operations may be performed in a different order or be omitted, or other operations may be added.

Although the embodiments are shown and described in the disclosure as above, the disclosure is not limited to the above-mentioned specific embodiments, and may be variously modified by those skilled in the art to which the disclosure pertains without departing from the gist of the disclosure of the accompanying claims. These modifications should also be understood to fall within the scope and spirit of the disclosure.

What is claimed is:

1. An electronic apparatus comprising:
a communication interface;
at least one memory for storing at least one instruction; and
at least one processor operatively connected to the communication interface and the at least one memory, and configured to execute the at least one instruction to:
identify a wireless connection state of a user terminal based on information on the wireless connection state of the user terminal in a case that an urgent call event to the user terminal occurs,
transmit a wireless connection enable request to a server, through the communication interface, by using a predetermined existing connection, based on identifying that the wireless connection state of the user terminal is a disable state, and
transmit an urgent call to the user terminal in a case that:
the at least one processor receives a response signal from the user terminal enabling its wireless connection after receiving the wireless connection enable request from the server, or
a predetermined time elapses.

2. The electronic apparatus of claim 1, wherein the information on the wireless connection state of the user terminal comprises the wireless connection state of the user terminal and a reason for disabling the wireless connection.

3. The electronic apparatus of claim 1, wherein the at least one processor is further configured to execute the at least one instruction to update the wireless connection state of the user terminal in the at least one memory, based on receiving identification information of the user terminal and the information on the wireless connection state of the user terminal.

4. The electronic apparatus of claim 1, wherein the at least one processor is further configured to execute the at least one instruction to, by transmitting a request for updating the wireless connection state of the user terminal to the server, reattempt the urgent call based on identifying that the urgent call is not transmitted to the user terminal.

5. The electronic apparatus of claim 4, wherein the at least one processor is further configured to execute the at least one instruction to transmit the urgent call to the user terminal based on received alternative identification information and based on receiving the alternative identification information of the user terminal from the server in response to the request for updating the wireless connection state of the user terminal.

6. The electronic apparatus of claim 1, wherein the predetermined existing connection comprises at least one of an internet connection or a nearby connection, and
wherein the nearby connection includes at least one of Bluetooth low energy (BLE), Nearby Share, or Quick Share.

7. A user terminal comprising:
a communication interface;
at least one memory for storing at least one instruction; and
at least one processor connected to the communication interface and the at least one memory, and configured to execute the at least one instruction to:
transmit, to a server, emergency contact information comprising identification information and a wireless connection state through the communication interface, and
enable a wireless connection, and transmit, to the server, a response signal to a wireless connection enable request based on receiving the wireless connection enable request for receiving an urgent call from the server.

8. The user terminal of claim 7, wherein the emergency contact information comprises the wireless connection state of the user terminal and a reason for disabling the wireless connection.

9. The user terminal of claim 7, wherein the at least one processor is further configured to execute the at least one instruction to enable the wireless connection through at least one of flight mode being turned off, subscriber identity module (SIM) card being turned on, or embedded SIM (eSIM) profile being turned on.

10. The user terminal of claim 7, wherein the at least one processor is further configured to execute the at least one instruction to:
notify the server that the user terminal is in a ready state for urgent call reception based on enabling the wireless connection and performing a cellular communication,
attempt to camp using voice over WiFi (VoWiFi) based on enabling the wireless connection and failing to perform the cellular communication, and
notify the server that the user terminal is in the ready state for the urgent call reception based on camping using the VoWiFi.

11. A method of an electronic apparatus, the method comprising:
identifying a wireless connection state of a user terminal based on information on the wireless connection state of the user terminal in a case that an urgent call event to the user terminal occurs;
transmitting a wireless connection enable request to a server by using a predetermined existing connection in a case that the wireless connection state of the user terminal is identified as being a disable state; and
transmitting an urgent call to the user terminal in a case that:
a response signal is received from the user terminal enabling its wireless connection by receiving the wireless connection enable request from the server, or
a predetermined time elapses.

12. The method of claim 11, wherein the information on the wireless connection state of the user terminal comprises the wireless connection state of the user terminal and a reason for disabling the wireless connection.

13. The method of claim 11, further comprising updating the wireless connection state of the user terminal in at least one memory in a case that identification information of the user terminal and the information on the wireless connection state of the user terminal are received.

14. The method of claim 11, further comprising, by transmitting a request for updating the wireless connection state of the user terminal to the server, reattempting the urgent call in a case that the urgent call is identified as not being transmitted to the user terminal.

15. The method of claim 14, further comprising transmitting the urgent call to the user terminal based on received alternative identification information in a case that the alternative identification information of the user terminal is received from the server in response to the request for updating the wireless connection state of the user terminal.

16. The method of claim 14, wherein the predetermined existing connection comprises at least one of an internet connection or a nearby connection, and
wherein the nearby connection includes at least one of Bluetooth low energy (BLE), Nearby Share, or Quick Share.
